(19) United States
(12) Patent Application Publication
(10) Pub. No.: US 2026/0161654 A1
(43) Pub. Date: Jun. 11, 2026

(54) Personalizing Edge Device Queries When Full Context is Unavailable

(71) Applicant: Google LLC, Mountain View, CA (US)

(72) Inventors: Branden Michael Archer, Mountain View, CA (US); Mekhola Mukherjee, Mountain View, CA (US)

(73) Assignee: Google LLC, Mountain View, CA (US)

(21) Appl. No.: 18/970,857

(22) Filed: Dec. 5, 2024

(51) Int. Cl. G06F 16/2457; G06F 16/2453; H04L 67/568

(52) U.S. Cl. CPC G06F 16/24575; G06F 16/24542; G06F 16/24578; H04L 67/568

(57) ABSTRACT

A method includes obtaining a plurality of contextual data elements associated with a user of a user device. For each respective contextual data element, the method includes determining a corresponding weight indicating an amount of relevance of the respective contextual data element to the user. The method includes determining a context based on the corresponding weight of each respective contextual data element. The context includes a portion of the contextual data elements from the plurality of contextual data elements. The method includes sending the context to the user device. The user device is configured to store the context locally at the user device based on receiving the context.

### TECHNICAL FIELD

This disclosure relates to personalizing edge device queries when full context is unavailable.

### BACKGROUND

User devices have increasingly become capable of querying large language models (LLMs) either by making requests to remote servers or by utilizing on-device models. LLM queries typically include a query and accompanying context, where the context may include information that is generally available on the remote servers. In scenarios where server-side information is essential to process an LLM query effectively, it is often more suitable for the user device to delegate the query to be performed at the remote server. However, user devices are not always connected to a network, which can prevent them from requesting the remote server to process LLM queries. While user devices may have the capability to query an on-device model, the absence of sufficient context may result in unhelpful or incomplete query results. This presents a significant challenge in ensuring that user devices are capable of consistently providing accurate and useful responses to LLM queries, regardless of network connectivity.

### SUMMARY

One aspect of the disclosure provides a computer-implemented method that when executed on data processing hardware causes the data processing hardware to perform operations for personalizing user device queries when full context is unavailable. The operations include obtaining a plurality of contextual data elements associated with a user of a user device. For each respective contextual data element, the operations include determining a corresponding weight indicating an amount of relevance of the respective contextual data element to the user. The operations include determining a context based on the corresponding weight of each respective contextual data element. The context includes a portion of the contextual data elements from the plurality of contextual data elements. The operations include sending the context to the user device. The user device is configured to store the context locally at the user device based on receiving the context.

Implementations of the disclosure may include one or more of the following optional features. In some implementations, the operations further include receiving a query at the user device, retrieving, using the user device, the context stored locally at the user device, and processing the query and the retrieved context to generate a response to the query using a neural network model that resides at the user device. In these implementations, the operation may further include determining to execute the query locally at the user device. Here, retrieving the context stored locally at the user device is based on determining to execute the query locally at the user device. Determining to execute the query locally at the user device may include determining that communication between the user device and the data processing hardware is currently unavailable. In these implementations, the neural network model may include an automated speech recognition model or a large language model.

In some examples, for each respective contextual data element, the operations further include determining a corresponding recency of the respective contextual data element. The recency indicating how recently the respective contextual data element was created or updated. Here, determining the corresponding weight is based on the corresponding recency of the respective contextual data element. For each respective contextual data element, the operations may further include determining a corresponding relationship between the respective contextual data element and preferences of the user. Here, determining the corresponding weight is based on the corresponding relationship between the respective contextual data element and preferences of the user. In some implementations, the operations further include receiving contextual cues suggesting particular contextual data elements relevant to the user from the user device. In these implementations, determining the corresponding weight is based on the contextual cues.

In some examples, the operations further include ranking the contextual data elements in the portion of the contextual data elements of the context based on the corresponding weight of each respective contextual data element in the portion of the contextual data elements and generating an ordered context list based on the ranked contextual data elements. In these examples, sending the context to the user device includes sending the context to the user device based on the ordered context list. The operations may further include: for each respective contextual data element in the portion of the contextual data elements of the context, determining a corresponding temporal relevance of the respective contextual data element; and sending each corresponding temporal relevance to the user device.

In some implementations, each corresponding temporal relevance indicates at least one of an occurrence time indicating when an event associated with the respective contextual data element will occur or a deletion time indicating when the respective contextual data element will no longer be relevant to the user. The operations may further include obtaining the plurality of contextual data elements from a plurality of online service providers. Each online service provider is associated with a respective topic of contextual data elements. In some examples, the operations further include obtaining the plurality of contextual data elements from a directed graph including a plurality of topic nodes and a plurality of intermediate nodes. Each topic node is associated with a respective topic of contextual data elements. Each intermediate node is associated with a respective collection of information related to one of the topic nodes.

Another aspect of the disclosure provides a system that includes data processing hardware and memory hardware storing instructions that when executed on the data processing hardware causes the data processing hardware to perform operations. The operations include obtaining a plurality of contextual data elements associated with a user of a user device. For each respective contextual data element, the operations include determining a corresponding weight indicating an amount of relevance of the respective contextual data element to the user. The operations include determining a context based on the corresponding weight of each respective contextual data element. The context includes a portion of the contextual data elements from the plurality of contextual data elements. The operations include sending the context to the user device. The user device is configured to store the context locally at the user device based on receiving the context.

Implementations of the disclosure may include one or more of the following optional features. In some implementations, the operations further include receiving a query at the user device, retrieving, using the user device, the context stored locally at the user device, and processing the query and the retrieved context to generate a response to the query using a neural network model that resides at the user device. In these implementations, the operation may further include determining to execute the query locally at the user device. Here, retrieving the context stored locally at the user device is based on determining to execute the query locally at the user device. Determining to execute the query locally at the user device may include determining that communication between the user device and the data processing hardware is currently unavailable. In these implementations, the neural network model may include an automated speech recognition model or a large language model.

In some examples, for each respective contextual data element, the operations further include determining a corresponding recency of the respective contextual data element. The recency indicating how recently the respective contextual data element was created or updated. Here, determining the corresponding weight is based on the corresponding recency of the respective contextual data element. For each respective contextual data element, the operations may further include determining a corresponding relationship between the respective contextual data element and preferences of the user. Here, determining the corresponding weight is based on the corresponding relationship between the respective contextual data element and preferences of the user. In some implementations, the operations further include receiving contextual cues suggesting particular contextual data elements relevant to the user from the user device. In these implementations, determining the corresponding weight is based on the contextual cues.

In some examples, the operations further include ranking the contextual data elements in the portion of the contextual data elements of the context based on the corresponding weight of each respective contextual data element in the portion of the contextual data elements and generating an ordered context list based on the ranked contextual data elements. In these examples, sending the context to the user device includes sending the context to the user device based on the ordered context list. The operations may further include: for each respective contextual data element in the portion of the contextual data elements of the context, determining a corresponding temporal relevance of the respective contextual data element; and sending each corresponding temporal relevance to the user device.

In some implementations, each corresponding temporal relevance indicates at least one of an occurrence time indicating when an event associated with the respective contextual data element will occur or a deletion time indicating when the respective contextual data element will no longer be relevant to the user. The operations may further include obtaining the plurality of contextual data elements from a plurality of online service providers. Each online service provider is associated with a respective topic of contextual data elements. In some examples, the operations further include obtaining the plurality of contextual data elements from a directed graph including a plurality of topic nodes and a plurality of intermediate nodes. Each topic node is associated with a respective topic of contextual data elements. Each intermediate node is associated with a respective collection of information related to one of the topic nodes.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system executing a context generator.

FIG. 2 is a schematic view of an example plurality of online service providers.

FIG. 3 is a schematic view of an example directed graph.

FIG. 4 is a schematic view of an example query execution process.

FIG. 5 is a schematic view of an example scheduling process.

FIG. 6 is a flowchart of an example arrangement of operations for a computer-implemented method of personalizing user device queries when full context is unavailable.

FIG. 7 is a schematic view of an example computing device that may be used to implement the systems and methods described herein.

Like reference symbols in the various drawings indicate like elements.

### DETAILED DESCRIPTION

User devices (i.e., edge devices), such as mobile phones, have increasingly become capable of querying large language models (LLMs) either by making requests to servers or by utilizing on-device models. LLM queries typically include a query and associated context. The context for a query may include information that is generally available at a remote computing device. In scenarios where server-side information is essential to service an LLM query, it is often more suitable for the user device to delegate the query to be performed at the remote server. However, user devices are not always connected to a network, which means they may not always be able to request the remote computing device to process an LLM query. While a user device may be capable of querying an on-device model, the absence of sufficient context can cause the query result to be unhelpful.

A user device with an on-device LLM may send a query to its model along with relevant context. Yet, if the query requires information that is typically only available server-side, the user device may lack the necessary information to satisfactorily process the query locally. A naive solution to this problem would be to duplicate the information from the remote computing device on the user device, thereby providing the user device with sufficient information to process the query. However, this approach may not be feasible due to several constraints. These constraints include the inability of the user device to store a copy of the information from the remote computing device due to insufficient storage space, lack of bandwidth to receive a complete copy of the information from the remote computing device, inability to locally process all available information either efficiently or effectively, and a user of the user device being unwilling to bear the cost of periodically retrieving a large amount of information from the remote computing device.

Accordingly, implementations herein are directed towards a context generator that personalizes user device queries when full context is unavailable. The context generator obtains a plurality of contextual data elements associated with a user of a user device. For each respective contextual data element, the context generator determines a corresponding weight that indicates an amount of relevance of the respective contextual data element to the user. The context generator determines a context based on the corresponding weight of each respective contextual data element. The context includes a portion of the contextual data elements from the plurality of contextual data elements. The contextual generator sends the context to the user device. Based on receiving the context, the user device is configured to store the context locally at the user device.

Advantageously, by determining the context which includes the portion of the contextual data elements (instead of the entire plurality of contextual data elements), the context generator reduces the amount of contextual data elements such the context may be stored locally at the user device. Accordingly, the user device may process queries locally using the context stored at the user device without having to query any remote computing device or system. Here, the context stored at the user device represents the relevant context to the user such that the user device may sufficiently respond to queries without having access to the plurality of contextual data elements available to the remote computing system. Thus, when the user device is unable to communicate with the remote computing system and/or the user device determines that it is more resource efficient, the user device may determine to execute the query locally rather than sending the query to the remote computing device for execution.

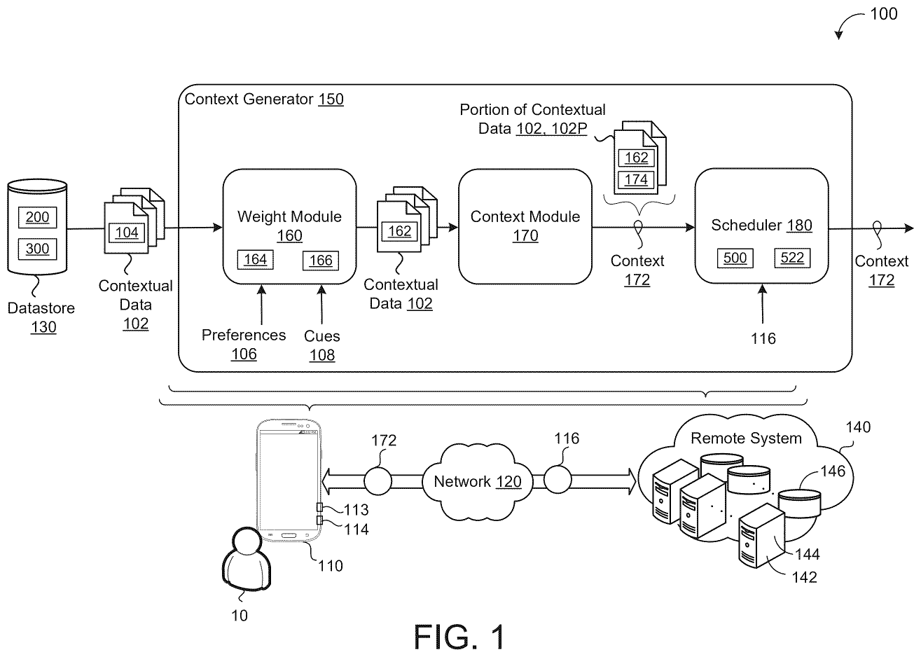

Referring to FIG. 1, in some implementations, a system 100 includes a remote computing system 140 in communication with one or more user devices 110 each associated with a respective user 10 via a network 120, such as the Internet, a local area network (LAN), a wide area network (WAN), a cellular network, or a wireless network. The remote computing system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote computing system 140 is configured to communicate with the user device 110 via the network 120. The user device 110 may correspond to any computing device, such as a desktop workstation, a laptop workstation, or a mobile device (i.e., a smart phone). Each user device 110 includes computing resources 113 (e.g., data processing hardware) and/or storage resources 114 (e.g., memory hardware).

The remote computing system 140 and/or the user device 110 may execute a context generator 150. In some examples, the remote computing system 140 executes the context generator 150. In other examples, the user device 110 executes the context generator 150. In yet other examples, some components of the context generator 150 execute on the remote computing system 140 while other components of the context generator 150 execute on the user device 110. The context generator 150 includes a weight module 160, a context module 170, and a scheduler 180.

The weight module 160 is configured to obtain a plurality of contextual data elements 102 associated with the user 10 of the user device 110. In the example shown, the plurality of contextual data elements 102 includes three (3) contextual data elements 102 for the sake of clarity only, as the plurality of contextual data elements 102 may include any number of contextual data elements 102. The weight module 160 may obtain the plurality of contextual data elements 102 from a datastore 130. In some examples, the datastore 130 is overlain on the memory hardware 146 of the remote computing system 140. The plurality of contextual data elements 102 may represent the context related to the user 10 that is available to the remote computing system 140. Thus, the plurality of contextual data elements 102 may all be available to the remote computing system 140 when the remote computing system 140 processes queries. In other examples, the datastore 130 represents one or more online resources (e.g., web pages, blogs, whitepapers, etc.) storing data associated with the user 10 that the context generator 150 communicates with over the network 120. The weight module 160 may obtain the plurality of contextual data elements 102 from a plurality of online service providers 200 and/or a directed graph 300.

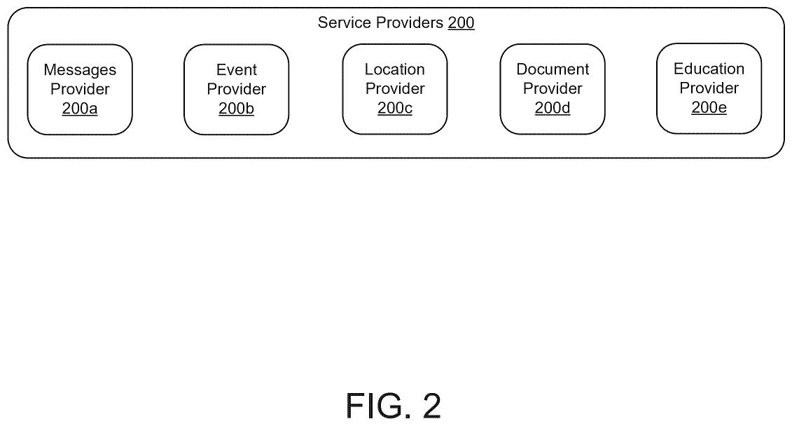

FIG. 2 illustrates an example plurality of online service providers 200, 200a-e. The plurality of online service providers 200 may access and provide information from various data sources, such as user accounts and publicly available information. The plurality of online service providers 200 may include any number of online service providers 200, each having a different focus or scope of information. That is, each online service provider 200 is associated with a respective topic of contextual data elements 102, which may be used to form a context 172 (FIG. 1).

In the example shown, a messages online service provider 200, 200a is associated with contextual data elements 102 including messages, such as email messages, from the user account or other sources; an event online service provider 200, 200b is associated with contextual data elements 102 including events, such as calendar events, from the user account or other sources; a location online service provider 200, 200c is associated with contextual data elements 102 including locations, such as navigation details, from the user account, the location of the user device, or other sources; a document online service provider 200, 200d is associated with contextual data elements 102 including documents, such as vacation plans, from the user account or other sources; and an education online service provider 200, 200e is associated with contextual data elements 102 including education information, such as encyclopedia entries, from the user account or other sources. The online service providers 200 in the example shown are exemplary only and do not limit the scope of the online service providers 200. Other online service providers 200 may be associated with other topics of contextual data elements 102, such as payment history, social media, news, entertainment, health, etc. The user provides explicit authorization for the context generator 150 to access the contextual data elements 102 from each service providers 200, and may further define which type of contextual data elements 102 the context generator 150 has permission to access and other types of contextual data elements 102 that the context generator 150 does not have permission to access. The user may revoke permission for the context generator 150 to access contextual data elements from any service provider at any time.

Each online service provider 200 may output information in any appropriate format, such as text, audio, video, image, etc., that can be formed into the context 172. The output information may be verbatim from the original sources, or it can be a derivative of the original information, such as a summary, a translation, a synthesis, a recommendation, etc. The output information may be generated by various techniques, such as server-side large language models (LLMs) or other natural language processing (NLP) models. The output information may be based on various criteria, such as preferences of the user 10, usage history of the user device 110 by the user 10, the location of the user device 110, the intent of the user 10, the profile of the user 10, feedback from the user 10, etc. The output information can be dynamic, adaptive, personalized, and contextualized for the user 10.

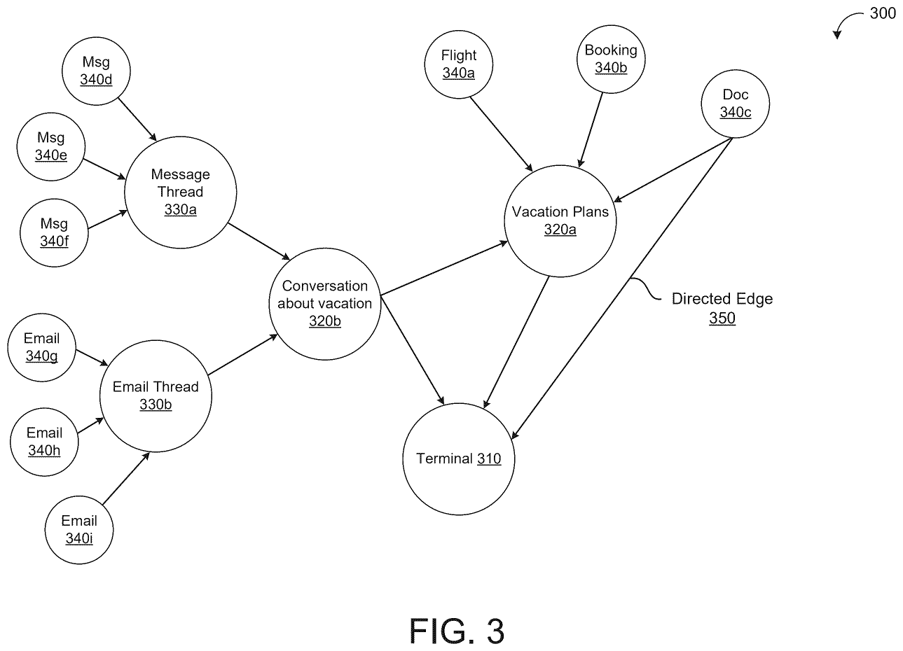

FIG. 3 illustrates an example directed graph 300. The directed graph 300 includes a terminal 310, a plurality of topic nodes 320, a plurality of intermediate nodes 330, a plurality of data nodes 340, and a plurality of directed edges 350. The terminal 310 is a central node that receives information from all other nodes in the directed graph 300 and represents the most relevant information for the user. Each directed edge 350 represents a data flow (e.g., denoted by the direction of the arrow) between two of the nodes in the directed graph 300. Each topic node 320 is associated with a respective topic of contextual data elements 102 that relate to the user's interests, preferences, activities, or goals. Topic nodes 320 may receive information from other topic nodes 320, intermediate nodes 330, and/or data nodes 340 and provide information to the terminal 310. Each intermediate node 330 is associated with a respective collection of information related to one of the topic nodes 320 or a derived information that results from an analysis of the data nodes 340. Intermediate nodes 330 receive information from data nodes 340 and/or other intermediate nodes 330 and provide information to topic nodes 320 and/or the terminal 310.

The data nodes 340 represent pieces of information that are obtained from various information sources, such as the user's online accounts, other users that share information with the user, or publicly available information. Thus, the data nodes 340 include publicly available information and information from user accounts. The data nodes 340 provide information to intermediate nodes 330 and/or topic nodes 320. In some examples, the directed graph 300 fans out in all directions from the terminal 310. Thus, intermediate nodes 330 and topic nodes 320 may be combined until the information ultimately flows to the terminal 310. The closer the node is to the terminal 310, the more relevant it is expected to be to the user 10. The user provides explicit authorization for the context generator 150 access contextual data elements 102 from the directed graph 300. The user may further define which type of contextual data elements 102 the context generator 150 has permission to access and other types of contextual data elements 102 that the context generator 150 does not have permission to access. The user may revoke permission for the context generator 150 to access contextual data elements 102 the directed graph 300 at any time.

In the example shown, the directed graph 300 includes a first topic node 320, 320a associated with the contextual data elements 102 regarding vacation plans and a second topic node 320, 320b associated with contextual data elements 102 regarding conversation about vacation. The first topic node 320a receives information from three data nodes 340, 340a-c and provides information to the terminal 310. The first data node 340a provides information regarding flights, the second data nodes 340b provides information regarding bookings, and the third data node 340c provides information regarding travel documents. Moreover, the third data node 340c provides the information to the first topic node 320a and directly to the terminal 310.

Continuing with the example shown, the second topic node 320b receives information from two intermediate nodes 330a, 330b and provides information to the first topic node 320a and the terminal 310. The first intermediate node 330a is associated with a respective collection of information regarding messages related to the conversation about the vacation from the second topic node 320b. The first intermediate node 330a receives data nodes 340d-f each related to a message in a message thread regarding the conversation about vacation. The second intermediate node 330b is associated with a respective collection of information regarding emails related to the conversation about vacation from the second topic node 320b. The second intermediate node 330b receives data nodes 340g-i each related to an email in an email thread regarding the conversation about vacation.

Referring back to FIG. 1, for each respective contextual data element 102 of the plurality of contextual data elements 102, the weight module 160 is configured to determine a corresponding weight 162 indicating an amount of relevance of the respective contextual data element 102 to the user 10. Put another way, the corresponding weight 162 of each respective contextual data element 102 represents the degree to which the respective contextual data element 102 is relevant to the user 10. The corresponding weight 162 may be represented by a numerical value within a predefined range. For instance, the numerical value may range from ‘0’ to ‘1,’ where ‘0’ indicates the lowest amount of relevance to the user 10, and ‘1’ indicates the highest amount of relevance to the user 10, Intermediate values between ‘0’ and ‘1’ represent varying degrees of relevance, with values closer to ‘1’ indicating higher relevance and values closer to ‘0’ indicating lower relevance. For example, if the user 10 is interested in sports news, a contextual data element 102 related to a recent football match may receive a weight 162 of ‘0.9,’ indicating high relevance. Conversely, a contextual data element 102 about a topic unrelated to the interests of the user, such as a cooking recipe, may receive a weight 162 of ‘0.1,’ indicating low relevance. As will become apparent, the corresponding weight 162 determined for each respective contextual data element 102 prioritizes whether the context generator 150 selects the respective contextual data element 102 to send to the user device 110 or not.

In some implementations, for each respective contextual data element 102, the weight module 160 determines a corresponding recency 164 of the respective contextual data element 102 whereby the corresponding recency 164 indicates how recently the respective contextual data element 102 was created or updated. The recency 164 indicates how recently the respective contextual data element 102 was created or updated. In some examples, each respective contextual data element 102 is associated with a corresponding timestamp 104. The timestamp 104 may indicate when the respective contextual data element 102 was created and/or when the data of the respective contextual data element 102 was last updated. Thus, the weight module 160 determines the corresponding recency 164 of the respective contextual data element 102 based on the corresponding timestamp 104 associated with the respective contextual data element 102. In particular, the corresponding timestamp 104 provides a precise indication of the creation or last update time of the respective contextual data element 102. By comparing a current time with the timestamp 104, the weight module 160 may determine the corresponding recency 164, which reflects the age of the respective contextual data element 102. In these implementations, the weight module 160 may determine the corresponding weight 162 for the respective contextual data element 102 based on the corresponding recency 164 determined for the respective contextual data element 102. Here, the weight module 160 ensures that the most up-to-date and relevant contextual data elements 102 are associated with the highest corresponding weights 162.

In some examples, for each respective contextual data element 102, the weight module 160 determines a corresponding relationship 166 between the respective contextual data element and preferences 106 of the user 10. The preferences 106 may be provided by the user 10 via the user device 110. Additionally or alternatively, the user device 110 may determine the preferences 106 of the user 10 based on prior usage data of the user device 110. In these examples, the weight module 160 may determine the corresponding weight 162 for the respective contextual data element 102 based on the corresponding relationship 166 between the respective contextual data element 102 and the preferences 106 of the user 10. For instance, the preferences 106 of the user 10 may indicate that the user 10 does not use the map functionality of the user device 110. Here, the weight module 160 may determine a low corresponding weight 162 for a respective contextual data element 102 of past driving routes of the user 10 because of the preferences 106 indicating that the user 10 does not use the map functionality.

Moreover, the weight module 160 may also consider other contextual data elements 102 that are more relevant to the preferences 106 of the user 10. For example, if the preferences 106 indicate that the user 10 frequently uses the calendar application on the user device 110, the weight module 160 may assign a higher corresponding weight 162 to contextual data elements 102 related to calendar events. As such, the weight module 160 prioritizes contextual data elements 102 that aligns more closely with the actual usage patterns and preferences of the user 10. In some configurations, the weight module 160 may dynamically adjust the corresponding weights 162 over time as the preferences 106 of the user 10 evolve. For instance, if the user 10 begins to use the map functionality more frequently, the weight module 160 may increase the corresponding weight 162 assigned to contextual data elements 102 related to driving routes.

The weight module 160 may receive contextual cues 108 from the user device 110 suggesting particular contextual data elements 102 relevant to the user 10. The contextual cues 108 may correspond to various settings of the user device 110 provided by the user 10. For instance, the user 10 may configure the settings to prohibit the context generator 150 from using information from a user account associated with the user 10, thereby restricting the context generator 150 to only utilize publicly available information. In this scenario, the weight module 160 determines the corresponding weight 162 based on the received contextual cues 108. In particular, the weight module 160 assigns a higher corresponding weight 162 to a respective contextual data element 102 that includes public information. Conversely, the weight module 160 assigns a lower corresponding weight 162 to a respective contextual data element 102 that includes information associated with the user account, particularly when the contextual cue 108 indicates that the context generator 150 is prohibited from using information from the user account. For example, if the contextual cue 108 specifies that the context generator 150 should not access the user account information, the weight module 160 will prioritize public information by determining higher corresponding weights 162 for the public information.

The context module 170 receives the corresponding weight 162 determined for each respective contextual data element 102 of the plurality of contextual data elements 102 and determines a context 172 based on the corresponding weight 162 of each respective contextual data element 102. The context 172 includes a portion of the contextual data elements 102, 102P from the plurality of contextual data elements 102. As such, the context module 170 may determine the context 172 by selecting the portion of the contextual data elements 102P from the plurality of contextual data elements 102. In the example shown, the portion of the contextual data elements 102P includes two (2) contextual data elements 102 from the three (3) contextual data elements 102 in the plurality of contextual data elements 102. In some examples, the context module 170 determines the context 172 by selecting the top-N contextual data elements 102 from the plurality of contextual data elements 102 having the greatest corresponding weights 162. In other examples, for each respective contextual data element 102, the context module 170 determines whether the corresponding weight 162 of the respective contextual data element 102 satisfies a threshold value. Here, the context module 170 determines the context 172 by selecting the respective contextual data elements 102 that have corresponding weights 162 that satisfy the threshold value.

In some implementations, for each respective contextual data element 102 in the portion of the contextual data elements 102P of the context 172, the context module 170 determines a corresponding temporal relevance 174 of the respective contextual data element 102. Each corresponding temporal relevance 174 may indicate an occurrence of time indicating when an event associated with the respective contextual data element will occur. The occurrence of time may be a specific date and time or a time range during which the event is expected to occur. For example, if the contextual data element 102 pertains to a scheduled meeting, the temporal relevance 174 may indicate the exact time and date of the meeting. Additionally or alternatively, each corresponding temporal relevance 174 may indicate a deletion time indicating when the respective contextual data element will no longer be relevant to the user 10. As will become apparent, the deletion time may be used to manage the lifecycle of the contextual data elements 102 of the context 172, ensuring that outdated or irrelevant information is removed from the context 172. For instance, if the contextual data element 102 is related to a promotional offer, the deletion time may correspond to the expiration date of the offer, after which the contextual data element 102 would be considered irrelevant and could be deleted.

The context module 170 transmits the context 172, including the portion of the of the contextual data elements 102P with the corresponding weights 162 and the corresponding temporal relevance 174, to the scheduler 180. The scheduler 180 is configured to send the context 172, including the portion of the of the contextual data elements 102P with the corresponding weights 162 and the corresponding temporal relevance 174, to the user device 110. The user device 110 is configured to store the context 172 locally at the user device 110. In particular, the user device 110 may store the context at the memory hardware 114 of the user device 110. Moreover, the scheduler is configured to send each corresponding weight 162 and/or each corresponding temporal relevance 174 to the user device 110. Similarly, the user device 110 is configured to store the corresponding weights 162 and/or the corresponding temporal relevance 174 locally at the user device 110 (e.g., at memory hardware 114 of the user device 110).

The scheduler 180 may send the context 172 to the user device 110 in a format corresponding to the plurality of online service providers 200 and/or the directed graph 300 such that the user device 110 stores the context 172 in the format received by the scheduler 180. That is, the context 172 may include the portion of the contextual data elements 102 which corresponds to information derived from the plurality of online service providers 200 and/or the directed graph 300. For example, the portion of the contextual data elements 102 may correspond to information from the messages online service provider 200a and the document online service provider 200d (FIG. 2) whereby the portion of the contextual data elements 102 are arranged according to which online service provider 200 each contextual data element 102 is associated with. In another example, the portion of the contextual data elements 102 may correspond to the topic node 320b regarding conversation about vacation, the intermediate node 330b regarding the email thread 330b, and data nodes 340h, 340i (FIG. 3). Here, the information from these nodes may be most relevant to the user 10 such that the information from these nodes is provided to the user device 110. The context 172 may be arranged in the directed graph format and stored locally at the user device 110 in this manner.

In some configurations, the scheduler 180 is unable to transmit the entire context 172 to the user device 110 in a single instance. This limitation may arise due to various factors. For example, the size of the context 172 may exceed a predefined threshold that the scheduler 180 is capable of sending in one transmission. Alternatively, the connectivity of the user device 110 may only support the transfer of a portion of the context 172 at any given time. To address these limitations, the scheduler 180 may implement a scheduling process 500. The scheduling process 500 is configured to prioritize the transmission of specific contextual data elements 102 from the portion of the contextual data element 102P in the context 172. Thus, the scheduling process 500 ensures that the most critical or relevant contextual data elements 102 are transmitted first. The prioritization may be based on various criteria, such as the importance of the data, the urgency of the information, or the current connectivity state of the user device 110.

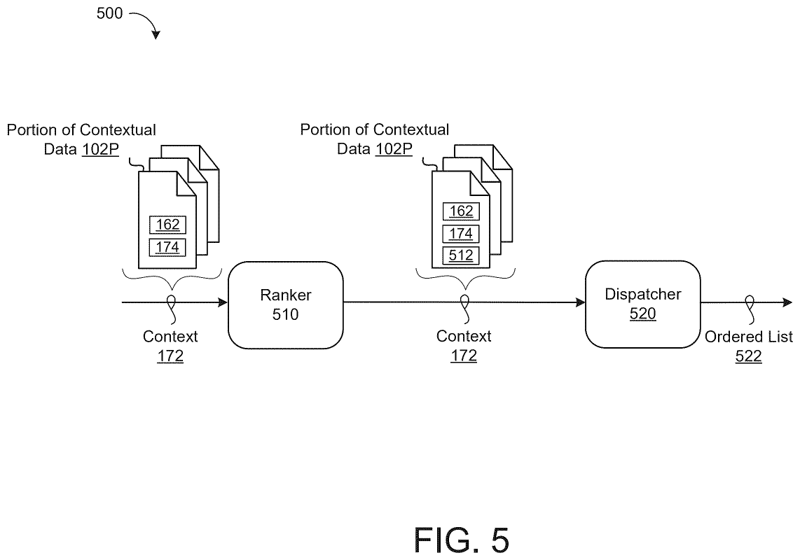

Referring now to FIG. 5, in some implementations, the scheduling process 500 executes a ranker 510 and a dispatcher 520. The ranker 510 is configured to rank the contextual data elements 102 in the portion of the contextual data elements 102P of the context 172 based on the corresponding weight 162 of each respective contextual data element 102 in the portion of the contextual data elements 102P. That is, the ranker 510 determines a rank 512 for each contextual data element 102 based on the corresponding weight 162. As discussed above, each corresponding weight 162 may include a numerical value that represents the amount of relevance of the respective contextual data element 102 to the user 10. On the other hand, the rank 512 indicates the relative position or priority of each respective contextual data element 102 among other contextual data elements 102 in the portion of the contextual data elements 102.

For instance, if a contextual data element 102 has a corresponding weight 162 of ‘0.8,’ the contextual data element 102 is considered more relevant than another contextual data element 102 with a corresponding weight 162 of ‘0.5.’ In some examples, the ranker 510 may determine the rank for each contextual data element 102 based on the corresponding temporal relevance 174 in addition to, or in lieu of, the corresponding weight 162. For example, a contextual data element 102 related to an upcoming meeting might be ranked higher due to its immediate temporal relevance.

The dispatcher 520 generates an ordered context list 522 based on the ranked contextual data elements 102. More specifically, the dispatcher 520 generates the ordered context list 522 based on the rank 512 determined for each contextual data element 102 of the context 172. The ordered context list 522 is a sequential arrangement of the contextual data elements 102 in the portion of the contextual data elements 102P that are organized according to the corresponding ranks 512. The ordered context list 522 serves as a prioritized schedule for the scheduler 180, ensuring that the most relevant and urgent contextual data elements 102 are sent to the user device 110 first. For example, if the ranker 510 assigns the highest rank 512 to a contextual data element 102 related to an urgent email and a lower rank 512 to a contextual data element 102 related to a routine task, the ordered context list 522 will place the urgent email at the top of the ordered context list 522, followed by the routine task. Thus, the ordered context list 522 prioritizes that the contextual data element 102 related to the urgent email is sent to the user device 110 before the contextual data element 102 related to the routine task.

Referring back to FIG. 1, the scheduler 180 may send the context 172 to the user device 110 based on the ordered context list 522 determined by the scheduling process 500. For instance, the scheduler 180 may determine that only one of the contextual data elements 102 from the context 172 may be sent to the user device 110 at a first instance in time. In this scenario, scheduler 180 selects the particular contextual data element 102 from the portion of contextual data elements 102P to send to the user device 110 according to the ordered context list 522. At a subsequent second instance in time, which occurs after the first instance in time, the scheduler 180 may determine that the remaining contextual data elements 102 from the context 172 can be sent to the user device 110. Consequently, the scheduler 180 sends the remaining contextual data elements 102 to the user device 110 at this second instance in time.

In some implementations, the scheduler 180 determines when to send the context 172 to the user device 110. That is, the scheduler 180 pushes the context 172 to the user device 110. In other implementations, the user device 110 determines when to receive the context 172 from the context generator 150 and transmits a request 116 to the context generator 150 requesting the context 172. Here, based on receiving the request 116 from the user device 110, the scheduler 180 may send the context 172 to the user device 110.

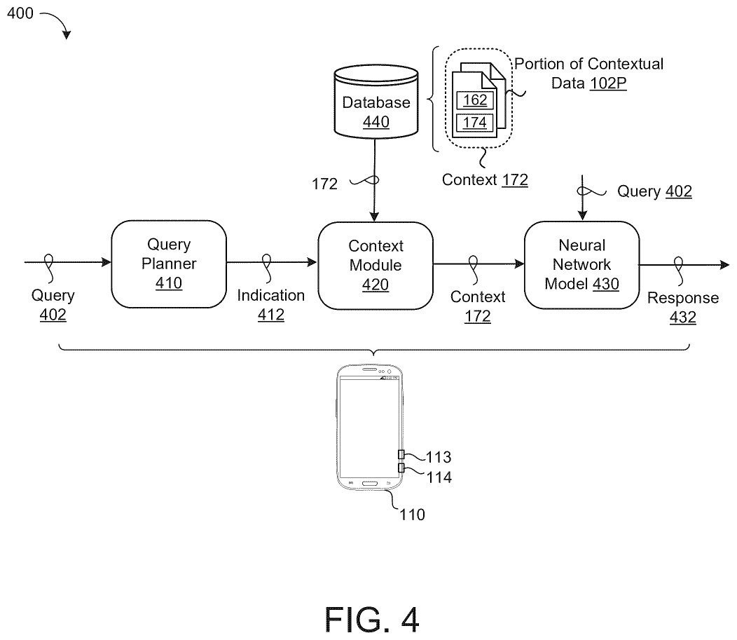

FIG. 4 illustrates an example query execution process 400 executed by the user device 110. The user device executes the query execution process (e.g., process) 400 after receiving and storing the context 172 locally at the user device 110. In particular, the user device 110 may store the context 172 at a database 440 overlain on the memory hardware 114 of the user device 110. The process 400 includes a query planner 410, a context module 420, and a neural network model 430.

The user device 110 receives a query 402 from the user 10. The query 402 may be spoken by the user 10 and transcribed by an automated speech recognition system or provided as a textual input by the user 10. The query 402 may specify an action or task for the neural network model 430 to perform. The neural network model 430 may include an automated speech recognition model or a large language model. Thus, the query 402 may include speech such that the automated speech recognition model generates a transcription of the speech. On the other hand, the query may include a task, such scheduling a meeting for tomorrow, whereby the large language model determines the task to perform based on the query 402 and performs the task.

The query planner 410 is configured to determine whether to execute the query 402 locally at the user device 110 or remotely at the remote computing system 140. Based on determining to execute the query at the remote computing system 140, the query planner 410 transmits the query 402 to the remote computing system 140 which may use the plurality of contextual data elements 102 to generate a response for the query 402. On the other hand, the query planner 410 may determine to execute the query 402 locally at the user device 110. The query planner 410 generates an indication 412 informing the context module 420 that the query planner 410 determined to execute the query 402 locally at the user device 110. For instance, the query planner 410 may determine to execute the query 402 locally at the user device 110 by determining that communication between the user device 110 and the data processing hardware 144 of the remote computing system 140 is currently unavailable. Moreover, the query planner 410 may determine to execute the query 402 locally at the user device 110 by determining that the user device 110 the context 172 stored locally at the user device 110 is sufficient to answer the query 402. The query planner 410 is optional such that the query 402 may be directly sent to the context module 420 when the process 400 omits the query planner 410.

The context module 420 retrieves the context 172 stored locally at the user device 110 (e.g., at the database 440 of the user device 110). The context module 420 may retrieve the context 172 based on receiving the indication 412 from the query planner 410 indicating that the query planner 410 determined to execute the query 402 locally at the user device 110. The context module 420 transmits the context 172 to the neural network model 430. The neural network model 430, which resides at the user device 110, processes the query 402 and the retrieved context 172 to generate a response 432 to the query 402. For instance, the response 432 may include a transcription of an utterance spoken by the user 10 or a confirmation of an action performed by the neural network model 430.

In some implementations, the neural network model 430 uses the temporal relevance 174 of each respective contextual data element 102 in the portion of the respective contextual data elements 102P of the context 172 to determine which contextual data elements 102 are relevant when processing the query 402. In particular, the temporal relevance 174 may represent an occurrence time indicating when an event associated with the respective contextual data element 102 is expected to occur. The neural network model 430 may compare the current time with the occurrence time to determine the relevance of each respective contextual data element 102 to the query 402. Although each contextual data element 102 in the portion of contextual data elements 102P of the context 172 being relevant to the user 10, not all of the contextual data elements 102 are relevant to every query 402. Instead, the contextual data elements 102 encompass a broad spectrum of relevant information that serve a diverse array of queries 402 that the user 10 may submit. cover a range of relevant information for a diverse range of queries 402 the user 10 may submit. Thus, by determining whether each contextual data element 102 from the portion of contextual data elements 102P is relevant to the query 402, the process 400 further narrows down the relevant information for a particular query 402.

Moreover, the process 400 may execute lifecycle management on the contextual data elements 102 stored locally at the user device 110 based on the corresponding temporal relevance 174 of each respective contextual data element 102. That is, the temporal relevance 174 may also represents a deletion time, which indicates when the respective contextual data element 102 will no longer be relevant to the user 10 for processing queries 402. As a result, the process 400 may delete the respective contextual data elements 102 when the current time surpasses the deletion time. In short, the process 400 leverages the temporal relevance 174 to both determine the relevance of contextual data elements 102 for query processing and manage the lifecycle of the contextual data elements 102 on the user device 110. Thus, the process 400 ensures that relevant contextual data elements 102 from the portion of the contextual data elements 102P of the context 172 are utilized for query 402 processing and outdated contextual data elements 102 are removed from the user device 110.

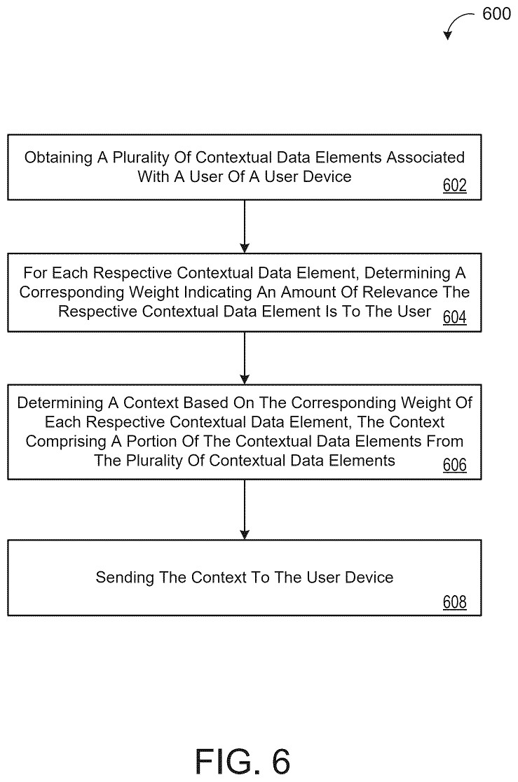

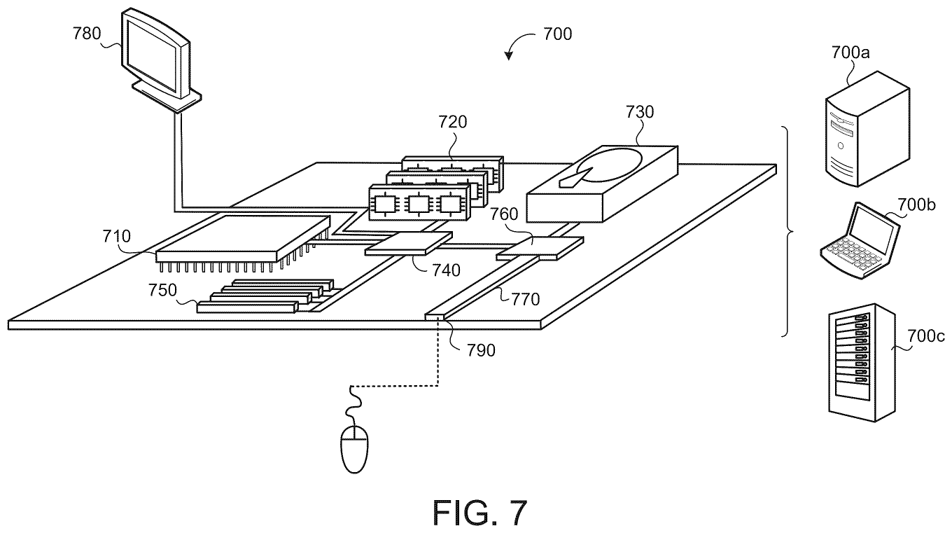

FIG. 6 illustrates a flowchart of an example arrangement of operations for a computer-implemented method 600 of personalizing user device queries when full context is unavailable. The method 600 may execute on data processing hardware 710 (FIG. 7) using instructions stored on memory hardware 720 (FIG. 7). The data processing hardware 710 and the memory hardware 720 may reside on the user device 110 and/or the remote computing system 140 of FIG. 1 each corresponding to a computing device 700 (FIG. 7).

At operation 602, the method 600 includes obtaining a plurality of contextual data elements 102 associated with a user 10 of a user device 110. At operation 604, the method 600 includes, for each respective contextual data element 102, determining a corresponding weight 162 that indicates an amount of relevance of the respective contextual data element 102 to the user 10. At operation 606, the method 600 includes determining a context 172 based on the corresponding weight 162 of each respective contextual data element 102. The context 172 includes a portion of the contextual data elements 102P from the plurality of contextual data elements 102. At operation 608, the method 600 includes sending the context 172 to the user device 110. The user device 110 is configured to store the context 172 locally at the user device 110 based on receiving the context 172.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A computer-implemented method executed on data processing hardware that causes the data processing hardware to perform operations comprising:
receiving explicit authorization from a user of a user device that indicates a plurality of contextual data elements associated with the user that a contextual generator has permission to access;
accessing, by the contextual generator, the plurality of contextual data elements associated with the user of the user device, wherein the plurality of contextual data elements are obtained from a plurality of online service providers, each online service provider associated with a respective topic of contextual data elements;
for each respective contextual data element, determining a corresponding weight indicating an amount of relevance of the respective contextual data element to the user;
determining a context based on the corresponding weight of each respective contextual data element, the context comprising a portion of the contextual data elements from the plurality of contextual data elements; and
sending the context to the user device, wherein, based on receiving the context, the user device is configured to store the context locally at the user device,
wherein, after the user device stores the context locally, the user device is configured to process a query locally using the context stored at the user device and a neural network model that resides at the user device.

2. (canceled)

3. The method of claim 1, wherein the user device is further configured to:
determine to execute the query locally at the user device,
wherein the user device is configured to retrieve the context stored locally at the user device based on determining to execute the query locally at the user device.

4. The method of claim 3, wherein the user device is configured to determine to execute the query locally at the user device by determining that communication between the user device and the data processing hardware is currently unavailable.

5. The method of claim 1, wherein the neural network model comprises an automated speech recognition model or a large language model.

6. The method of claim 1, wherein the operations further comprise, for each respective contextual data element:
determining a corresponding recency of the respective contextual data element, the corresponding recency indicating how recently the respective contextual data element was created or updated,
wherein determining the corresponding weight is based on the corresponding recency of the respective contextual data element.

7. The method of claim 1, wherein the operations further comprise, for each respective contextual data element:
determining a corresponding relationship between the respective contextual data element and preferences of the user,
wherein determining the corresponding weight is based on the corresponding relationship between the respective contextual data element and the preferences of the user.

8. The method of claim 1, wherein the operations further comprise:
receiving, from the user device, contextual cues suggesting particular contextual data elements relevant to the user,
wherein determining the corresponding weight is based on the contextual cues.

9. The method of claim 1, wherein the operations further comprise:
ranking the contextual data elements in the portion of the contextual data elements of the context based on the corresponding weight of each respective contextual data element in the portion of the contextual data elements; and
generating an ordered context list based on the ranked contextual data elements,
wherein sending the context to the user device comprises sending the context to the user device based on the ordered context list.

10. The method of claim 1, wherein the operations further comprise:
for each respective contextual data element in the portion of the contextual data elements of the context, determining a corresponding temporal relevance of the respective contextual data element; and
sending each corresponding temporal relevance to the user device.

11. The method of claim 1, wherein each corresponding temporal relevance indicates at least one of:
an occurrence time indicating when an event associated with the respective contextual data element will occur; or
a deletion time indicating when the respective contextual data element will no longer be relevant to the user.

12. (canceled)

13. (canceled)

14. A system comprising:
data processing hardware; and
memory hardware in communication with the data processing hardware, the memory hardware storing instructions that when executed on the data processing hardware cause the data processing hardware to perform operations comprising:
receiving explicit authorization from a user of a user device that indicates a plurality of contextual data elements associated with the user that a contextual generator has permission to access;
accessing, by the contextual generator, the plurality of contextual data elements associated with the user of the user device, wherein the plurality of contextual data elements are obtained from a plurality of online service providers, each online service provider associated with a respective topic of contextual data elements;
for each respective contextual data element, determining a corresponding weight indicating an amount of relevance of the respective contextual data element to the user;
determining a context based on the corresponding weight of each respective contextual data element, the context comprising a portion of the contextual data elements from the plurality of contextual data elements; and
sending the context to the user device, wherein, based on receiving the context, the user device is configured to store the context locally at the user device,
wherein, after the user device stores the context locally, the user device is configured to process a query locally using the context stored at the user device and a neural network model that resides at the user device.

15. (canceled)

16. The system of claim 14, wherein the user device is further configured to:
determine to execute the query locally at the user device,
wherein the user device is configured to retrieve the context stored locally at the user device based on determining to execute the query locally at the user device.

17. The system of claim 16, wherein the user device is configured to determine to execute the query locally at the user device by determining that communication between the user device and the data processing hardware is currently unavailable.

18. The system of claim 14, wherein the neural network model comprises an automated speech recognition model or a large language model.

19. The system of claim 14, wherein the operations further comprise, for each respective contextual data element:
determining a corresponding recency of the respective contextual data element, the corresponding recency indicating how recently the respective contextual data element was created or updated,
wherein determining the corresponding weight is based on the corresponding recency of the respective contextual data element.

20. The system of claim 14, wherein the operations further comprise, for each respective contextual data element:
determining a corresponding relationship between the respective contextual data element and preferences of the user,
wherein determining the corresponding weight is based on the corresponding relationship between the respective contextual data element and the preferences of the user.

21. The system of claim 14, wherein the operations further comprise:
receiving, from the user device, contextual cues suggesting particular contextual data elements relevant to the user,
wherein determining the corresponding weight is based on the contextual cues.

22. The system of claim 14, wherein the operations further comprise:
ranking the contextual data elements in the portion of the contextual data elements of the context based on the corresponding weight of each respective contextual data element in the portion of the contextual data elements; and
generating an ordered context list based on the ranked contextual data elements,
wherein sending the context to the user device comprises sending the context to the user device based on the ordered context list.

23. The system of claim 14, wherein the operations further comprise:
for each respective contextual data element in the portion of the contextual data elements of the context, determining a corresponding temporal relevance of the respective contextual data element; and
sending each corresponding temporal relevance to the user device.

24. The system of claim 14, wherein each corresponding temporal relevance indicates at least one of:
an occurrence time indicating when an event associated with the respective contextual data element will occur; or
a deletion time indicating when the respective contextual data element will no longer be relevant to the user.

25. (canceled)

26. (canceled)
